(19) United States
(12) Patent Application Publication
(10) Pub. No.: US 2023/0008226 A1
(43) Pub. Date: Jan. 12, 2023

(54) System and Method for Monitoring Transaction Events

(71) Applicant: The Toronto-Dominion Bank, Toronto (CA)

(72) Inventors: Syrous DELAVARI-MARAGHI, Vaughan (CA); Ryan William O'SHAUGHNESSY, Ottawa (CA); Kevin Ka-Win YUEN, Toronto (CA)

(73) Assignee: The Toronto-Dominion Bank, Toronto (CA)

(21) Appl. No.: 17/476,599

(22) Filed: Sep. 16, 2021

Related U.S. Application Data
(63) Continuation-in-part of application No. 17/305,528, filed on Jul. 9, 2021.

(51) Int. Cl. G06Q 30/02; G06Q 40/02; G06Q 20/02; G06Q 20/38; G06Q 20/20; G06Q 20/40; G06F 9/54

(52) U.S. Cl. CPC G06Q 30/0226; G06Q 40/02; G06Q 20/02; G06Q 20/385; G06Q 20/202; G06Q 30/0238; G06Q 20/405; G06F 9/546

(57) ABSTRACT

A system and method are provided for monitoring transaction events. The method includes connecting the event processor device with at least one payment services channel and listening for events provided by the at least one payment services channel. The method also includes detecting an event associated with a masked transaction being facilitated by a payment service that masks a payment card number. The method also includes determining from the masked transaction a user identifier associated with the transaction, determining from the user identifier the payment card number, and confirming that the payment card number is linked to the loyalty program with the loyalty partner. When the payment card number is linked to the loyalty program, the method includes sending a message to the loyalty partner to have the loyalty partner execute a loyalty program action associated with the transaction that would have otherwise been masked at the point of sale.

### CROSS-REFERENCE TO RELATED APPLICATION(S)

This application is a continuation-in-part of U.S. patent application Ser. No. 17/305,528 filed on Jul. 9, 2021, the entire contents of which are incorporated herein by reference.

### TECHNICAL FIELD

The following relates generally to monitoring transaction events.

### BACKGROUND

Many loyalty programs are evolving from a one size fits all approach focused on aspirational travel rewards, to accessible everyday rewards offerings. Everyday rewards may include merchandise, discounts, cash back or other items of value that can be used more frequently and easily by the customer. Many new credit card offerings, for example, focus on the everyday rewards space rather than travel rewards.

One aspect of such the digital infrastructure required to provide such loyalty rewards offerings involves tracking payments that are eligible for rewards and coordinating between the loyalty platform and the loyalty partners.

A mechanism is found to be lacking for integrating and linking various loyalty partners. Moreover, there is not a readily available robust infrastructure to onboard new partners and facilitate the various services required to implement loyalty registrations, redemptions, and lifecycle management. This can include a lack of strategy for payment management, which requires a solution that adapts to the functionality of the loyalty platform and the manner in which loyalty rewards are awarded and linked with the loyalty platform.

### BRIEF DESCRIPTION OF THE DRAWINGS

Embodiments will now be described with reference to the appended drawings wherein:

FIG. 1 is a schematic diagram of an example computing environment.

FIG. 2 is a schematic diagram of a loyalty hub platform integrated with an enterprise system and one or more loyalty partners.

FIG. 3 is a schematic diagram illustrating the synchronous communication of microservices with each other.

FIG. 4 is a block diagram illustrating the integration of the loyalty hub platform with a loyalty partner system, enterprise system, and payment infrastructure.

FIG. 5 is a block diagram of an example configuration of a loyalty hub platform.

FIG. 6 is a block diagram of an example configuration of a loyalty partner system.

FIG. 7 is a block diagram of an example configuration of an enterprise system.

FIG. 8 is a block diagram of an example configuration of a client computing device associated with a user, customer, or client.

FIGS. 9a and 9b are a flow diagram of an example of computer executable instructions for linking loyalty programs via the loyalty hub platform.

FIGS. 10a and 10b are a flow diagram of an example of computer executable instructions for transfer loyalty points to a loyalty partner.

FIG. 11 is a sequence diagram illustrating a payment card number provisioning process.

FIG. 12 is a sequence diagram illustrating a linked loyalty points assignment process during a transaction.

FIGS. 13a and 13b are a sequence diagram illustrating eligibility and registration processes.

FIG. 14 is a sequence diagram illustrating a transaction history retrieval process.

FIG. 15 is a sequence diagram illustrating a partner registration process.

FIG. 16 is a flow diagram of an example of computer executable instructions for integrating loyalty program partner systems with an enterprise system.

FIG. 17 is a schematic diagram of an event processor configuration for the loyalty hub platform.

FIG. 18 is a schematic diagram illustrating a configuration for removing payment card industry (PCI) data from communications within the loyalty hub platform.

FIG. 19 is a flow diagram of an example of computer executable instructions for monitoring transaction events.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Merchants and other entities that wish to provide everyday rewards typically require a digital infrastructure, including a loyalty interface, app, webpage, etc., in order to integrate the everyday rewards into their existing product and/or service offerings. Moreover, it is found that there does not exist a mechanism or platform to integrate and link various loyalty partners, let alone a robust infrastructure to onboard new partners and facilitate the various services required to implement loyalty registrations, redemptions, and lifecycle management. For example, a financial institution providing debit and credit cards may require customized solutions for both their own loyalty program and any linking between that loyalty program and another loyalty program provided by a partner organization or business.

The following describes a loyalty hub platform that provides a scalable solution to onboard multiple loyalty partners and to link loyalty programs with a loyalty program provided by an enterprise such as a financial institution.

The loyalty hub platform described herein can also be configured to provide an event-driven implementation to decouple transactions from a set of microservices that is deployed by the loyalty platform to facilitate linking loyalty programs between a financial institution (FI) and loyalty partners. The proposed event driven configuration includes, for example:

(1) removing payment card industry (PCI) data from the cloud environment;

(2) recognizing product changes and mobile transactions that mask card numbers; and

(3) recognizing registered customers at the loyalty partner.

The event driven implementation thus integrates with a loyalty hub architecture that uses a set of six core microservices to facilitate linking loyalty programs between a FI card or account with everyday rewards programs offered by loyalty partners. These microservices facilitate dynamic event processing, interface requests, and the integration with the partners via a common backend hub which enables new partners to be added seamlessly with minimal additional efforts.

The architecture described below includes an event processor outside of the loyalty hub interface services. Channels exchange PCI data to non-PCI data to send to the microservices for product analysis and customer-level linking. Each microservice has an associated database for maintaining data. The event processor receives product changes and financial transactions from the book of records for a lifecycle management service and other payment notifications. The onboarding service decouples the business logic from partner integration.

The event driven architecture described below can also remove the PCI data from the cloud environment on which the loyalty hub platform is deployed. For credit cards, any call to the loyalty hub platform that requires truncated account data and customer identifiers. The channels capture this information and pass it with truncated and/or alternative numbers to the loyalty hub platform. For debit cards, an access card is associated with one customer only. However, each customer may have multiple accounts (e.g., chequing, savings, joint, etc.) and only the customer ID is captured for linking.

The event driven architecture can also recognize product changes and mobile transactions such as PayPal® and other third party payment services that mask certain information like the credit card linked to the account. In such a process flow, any product changes (new accounts, product transfers, etc.) are managed via event processing and analyzing customer impacts via lifecycle management microservices. For payment services like PayPal®, Samsung Pay® and Apple Pay®, transactions are hidden from partner payment systems. However, the event processor can recognize these payment services for the registered customers to notify them and the loyalty partners to assign acceleration points. That is, the event processor can monitor payment channels and decipher customer account cards/numbers to then be able to notify the loyalty partner to assign acceleration points and the like. This is in contrast to routine loyalty redemption events, wherein the loyalty partner has a list of bank identification numbers (BINs) to check for eligibility for applying the acceleration points.

Accordingly, the event processor provided herein can decouple and offload transaction processing from the microservices that provide the loyalty hub platform. The event processor can listen to book of record or other payment traffic to determine if purchases using eligible cards were made but not decipherable to the loyalty partner (e.g., by recognizing the member ID). The event processor can then leverage the loyalty platform to flag this for the loyalty partner.

It will be appreciated that while examples provided herein are directed to linking loyalty programs with financial institution payment cards, the principles discussed herein equally apply to other enterprise systems having loyalty programs that are to be linked with partner loyalty systems.

Certain example systems and methods described herein are able to monitor transaction events, e.g., to detect masked transactions. In one aspect, there is provided an event processor device for monitoring transaction events. The device includes a processor, a communications module coupled to the processor, and a memory coupled to the processor. The memory stores computer executable instructions that when executed by the processor cause the processor to connect the event processor device with at least one payment services channel via the communications module; and listen, via the communications module, for events provided by the at least one payment services channel. The memory also stores computer executable instructions that when executed by the processor cause the processor to detect an event associated with a masked transaction, the masked transaction being facilitated by a payment service that masks, at a point of sale, a payment card number issued by another party that is used by the payment service to execute the transaction, wherein the payment card number is associated with a loyalty program with a loyalty partner. The memory also stores computer executable instructions that when executed by the processor cause the processor to determine from the masked transaction a user identifier associated with the transaction, determine from the user identifier the payment card number, and confirm that the payment card number is linked to the loyalty program with the loyalty partner. The memory also stores computer executable instructions that when executed by the processor cause the processor to when the payment card number is linked to the loyalty program, send a message to the loyalty partner to have the loyalty partner execute a loyalty program action associated with the transaction that would have otherwise been masked at the point of sale.

In another aspect, there is provided a method of monitoring transaction events. The method is executed by an event processor device and includes connecting the event processor device with at least one payment services channel and listening for events provided by the at least one payment services channel. The method also includes detecting an event associated with a masked transaction, the masked transaction being facilitated by a payment service that masks, at a point of sale, a payment card number issued by another party that is used by the payment service to execute the transaction, wherein the payment card number is associated with a loyalty program with a loyalty partner. The method also includes determining from the masked transaction a user identifier associated with the transaction, determining from the user identifier the payment card number, and confirming that the payment card number is linked to the loyalty program with the loyalty partner. The method also includes, when the payment card number is linked to the loyalty program, sending a message to the loyalty partner to have the loyalty partner execute a loyalty program action associated with the transaction that would have otherwise been masked at the point of sale.

In another aspect, there is provided a non-transitory computer readable medium for monitoring transaction events. The computer readable medium includes computer executable instructions for connecting the event processor device with at least one payment services channel and listening for events provided by the at least one payment services channel. The computer readable medium also includes computer executable instructions for detecting an event associated with a masked transaction, the masked transaction being facilitated by a payment service that masks, at a point of sale, a payment card number issued by another party that is used by the payment service to execute the transaction, wherein the payment card number is associated with a loyalty program with a loyalty partner. The computer readable medium also includes computer executable instructions for determining from the masked transaction a user identifier associated with the transaction, determining from the user identifier the payment card number, and confirming that the payment card number is linked to the loyalty program with the loyalty partner. The computer readable medium also includes computer executable instructions for when the payment card number is linked to the loyalty program, sending a message to the loyalty partner to have the loyalty partner execute a loyalty program action associated with the transaction that would have otherwise been masked at the point of sale.

In certain example embodiments, the masked transaction can be associated with a third party payment account that is separate from a financial institution that issues the payment card number, wherein the third party payment account links one or more payment cards issued to the user to provide a separate electronic payment option.

In certain example embodiments, the event processor device can be coupled to message queues connected to each of a plurality of payment channels.

In certain example embodiments, the device can be further configured to detect an event associated with a standard transaction; remove payment card industry data from the standard transaction; and provide a modified transaction message to one or more microservices of a loyalty hub platform to process loyalty events. The event processor device can be integrated with the loyalty hub platform and coupled to the one or more microservices.

In certain example embodiments, the device can be configured to provide the loyalty partner with a range of card numbers for a financial institution configured to provide a loyalty hub platform for at least the loyalty partner, wherein the range of card numbers is used at the point of sale to determine whether the payment card number is linked to the loyalty program. The range of card numbers can be periodically updated at the loyalty partner by the loyalty hub platform.

In certain example embodiments, the event processor device can be integrated with a loyalty hub platform and coupled to one or more microservices, and wherein the loyalty hub platform is configured to: provide a first application programming interface (API) between the loyalty hub platform and one or more loyalty partner systems; provide an inbound traffic service to the platform, to receive data from the one or more loyalty partner systems via the first API; provide a second API between the platform and the at least one payment services channel to detect transactions; provide an outbound traffic service from the platform, to communicate with the one or more loyalty partner systems via at least one communication channel; configure a plurality of microservices within the platform, the plurality of microservices comprising a registration microservice to link loyalty accounts with enterprise accounts, a redemption microservice to associate the transactions with loyalty redemption events, a rules microservice to maintain sets of rules associated with loyalty partners, a profile management microservice to maintain profiles associated with accounts, and a lifecycle management microservice to manage lifecycle events; and orchestrate the plurality of microservices using: i) data received via the inbound traffic service, ii) transaction data detected via the second API, or both i) and ii), to update a corresponding loyalty partner system via the outbound traffic service to execute at least one of a registration event, a redemption event, a profile event, and a lifecycle event.

In certain example embodiments, the loyalty hub platform can be integrated with an enterprise system to link a first loyalty program associated with the enterprise system with at least one second loyalty program each associated with one of the loyalty partner systems. The enterprise system can provide a payment card for making purchases, the payment card being a physical card, an electronic card, or providing both the physical card and the electronic card. The device can be further configured to track purchases made using the payment card; link the purchases with a product or service provided by a merchant providing the second loyalty program associated with the one of the loyalty partner systems; and provide an additional loyalty reward based on the purchases.

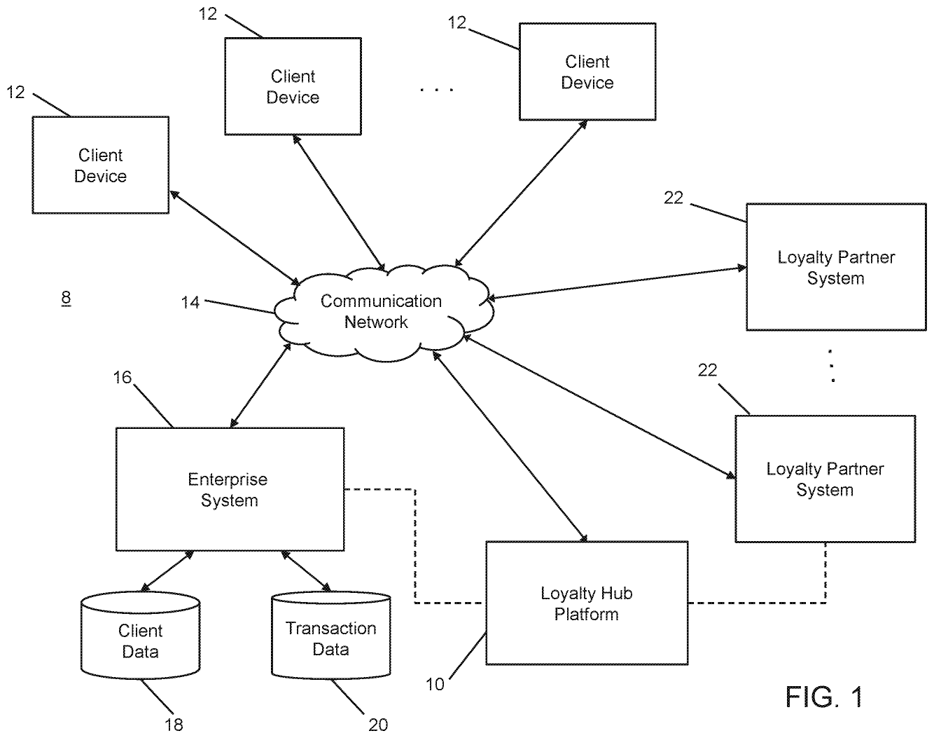

FIG. 1 illustrates an exemplary computing environment 8. In one aspect, the computing environment 8 may include a loyalty hub platform 10, one or more client devices 12, and a communications network 14 connecting one or more components of the computing environment 8.

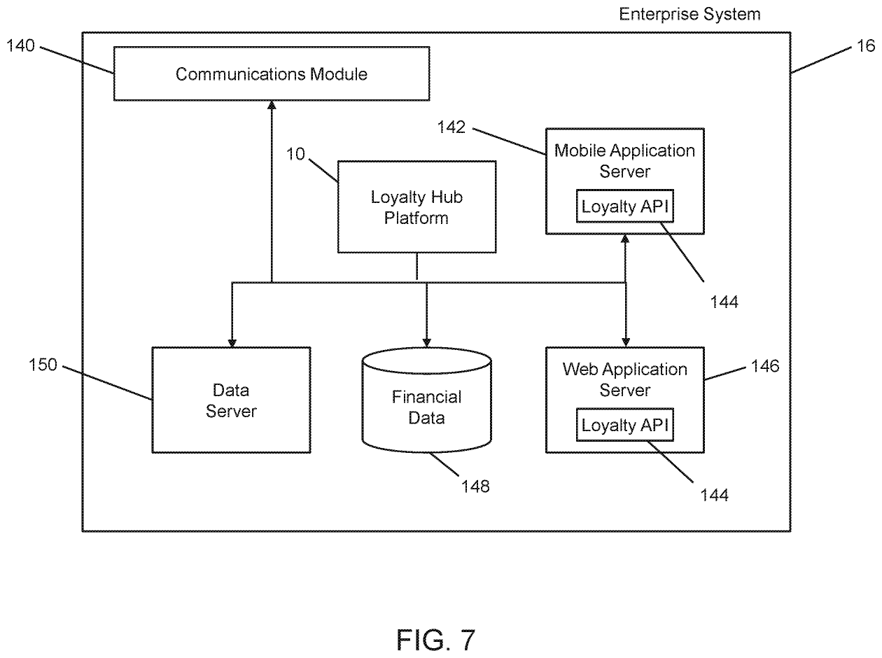

The computing environment 8 may also include an enterprise system 16 (e.g., a financial institution such as commercial bank and/or lender) that provides financial services accounts to users and processes financial transactions associated with those financial service accounts. While several details of the enterprise system 16 have been omitted for clarity of illustration, reference will be made to FIG. 7 below for additional details.

The enterprise system 16 includes or otherwise has access to a datastore for storing client data 18 and a datastore for storing transaction data 20. The loyalty hub platform 10 may have has access to the client data 18 and transaction data 20 via the enterprise system 16 or by direct access (not shown in FIG. 1). The client data 18 may include both data associated with a user of a client device 12 that interacts with the loyalty hub platform 10 and the enterprise system 16 (e.g., for participating in mobile and in-person banking at a point-of-sale device and for collecting and redeeming loyalty rewards) and transaction history data that is captured and provided with or maps to transaction entries in the transaction data 20, e.g., in the graphical user interface of a mobile or web-based banking application. The data associated with a user can include client profile data that may be mapped to corresponding financial data 148 (see FIG. 7) for that user. It can be appreciated that the financial data 148 shown in FIG. 7 could also include transaction data 20 and/or client data 18 shown in FIG. 1 and these datastores are shown separately for illustrative purposes. The client data 18 can include both data that is associated with a client as well as data that is associated with one or more user accounts for that client as recognized by the computing environment 8. For example, a client may have a banking/debit card and one or more credit cards issued by a bank or other financial institution (i.e., the enterprise system 16).

The data associated with a client may include, without limitation, demographic data (e.g., age, gender, income, location, etc.), preference data input by the client, and inferred data generated through machine learning, modeling, pattern matching, or other automated techniques. The client data 18 or transaction data 20 may also include historical interactions and transactions associated with the loyalty hub platform 10 and/or enterprise system 16, e.g., login history, search history, communication logs, documents, etc.

It can be appreciated that while the loyalty hub platform 10 and enterprise system 16 are shown as separate entities in FIG. 1, they may also be part of the same system. For example, the loyalty hub platform 10 can be hosted and provided within the enterprise system 16 as illustrated in FIG. 7.

Client devices 12 may be associated with one or more users. Users may be referred to herein as customers, clients, users, investors, depositors, correspondents, or other entities that interact with the enterprise system 16 and/or loyalty hub platform 10 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. For example, the user may use client device 12 to engage and interface with a mobile or web-based banking application which uses or incorporates the loyalty hub platform 10 to orchestrate the registration, collection, redemption, conversion, and transfer of loyalty rewards, such as points, accelerators to other points totals, credits or other values that can be exchanged for an everyday reward.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

In one embodiment, loyalty hub platform 10 may be implemented using one or more computer systems (e.g., server devices) configured to process and store information and execute software instructions to perform one or more processes consistent with the disclosed embodiments. In certain embodiments, although not required, loyalty hub platform 10 may be associated with one or more business entities. In certain embodiments, loyalty hub platform 10 may represent or be part of any type of business entity. For example, loyalty hub platform 10 may be a system associated with a commercial bank, credit union (e.g., enterprise system 16), a digital media service provider, or some other type of business having rewards programs. The loyalty hub platform 10 can also operate as a standalone entity that is configured to serve multiple business entities, e.g., to act as an agent therefor.

Referring back to FIG. 1, the loyalty hub platform 10 and/or enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the loyalty hub platform 10 and enterprise system 16. The cryptographic server may be used to protect the financial data 148 and/or client data 18 and/or transaction data 20 by way of encryption for data protection, digital signatures or message digests for data integrity, and by using digital certificates to authenticate the identity of the users and client devices 12 with which the enterprise system 16 and/or loyalty hub platform 10 communicates to inhibit data breaches by adversaries. It can be appreciated that various cryptographic mechanisms and protocols can be chosen and implemented to suit the constraints and requirements of the particular deployment of the loyalty hub platform 10 or enterprise system 16 as is known in the art.

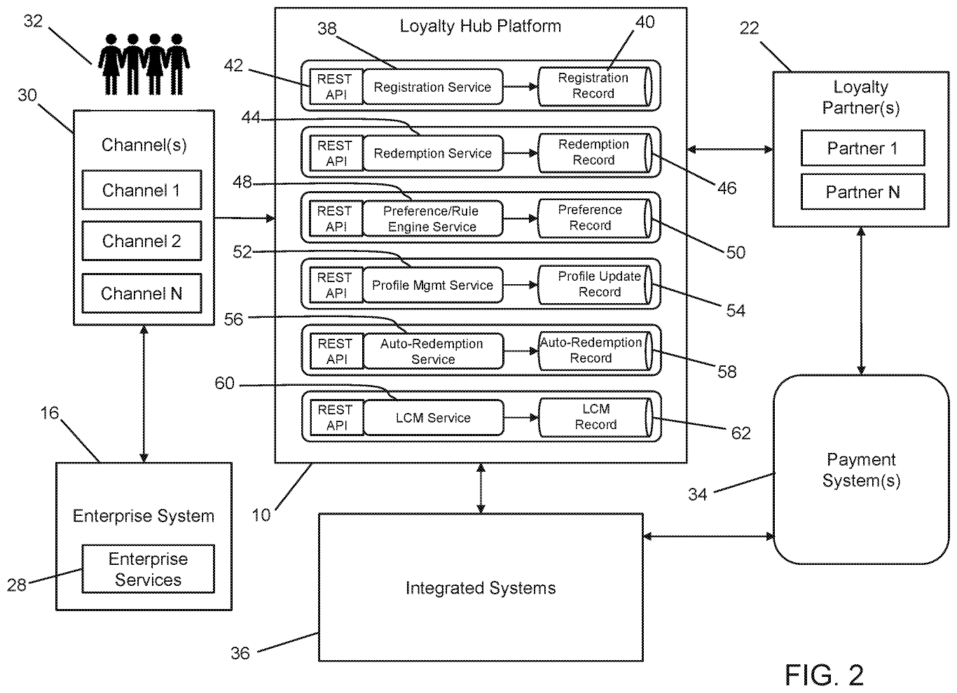

FIG. 2 provides an example of a configuration for integrating the loyalty hub platform 10 with the enterprise system 16, one or more loyalty partner systems 22 (e.g., Partner 1, . . . N for illustrative purposes); and one or more payment systems 34 used by the enterprise system 16 and loyalty partner system(s) 22 to enable customers 32 to process transactions. The customers 32 can also interact with the enterprise system 16 and the loyalty hub platform 10 via one or more communication channels 30, such as a mobile application, webpage or other via other channels 30 such as phone, text messaging, etc. Channels 1, 2, . . . N are shown for illustrative purposes. The loyalty hub platform 10 can also provide an intermediary entity enabling customers 32 to access or be redirected to the loyalty partner systems 22 via one of the channels 30 the customer 32 uses to interact with the enterprise system 16. For example, the customer 32 may be redirected to a loyalty app via a mobile banking app when managing registration, redemption, conversion or other processes related to rewards such as everyday rewards. Also shown in FIG. 2 are integrated systems 36 which can be separate (as shown) or part of the enterprise system 16 and/or payment system 34 to enable the loyalty hub platform 10 to access book of record (BoR) data, determine the eligibility of certain debit or credit cards, obtain access to financial transactions (e.g., transaction data 20 and/or additional financial-related data not available via the transaction data 20). The enterprise system 16 in FIG. 2 also includes enterprise services 28 that can be leveraged by the loyalty hub platform 10, e.g., messaging, notifications, data analytics, etc.

The architecture for the loyalty hub platform 10 as shown in FIG. 2 includes a set of microservices to perform registration, redemption, apply rules, handle profiles, enable automatic redemptions, and handle lifecycle management. A microservice is a webservice which has a small and well-defined scope and is loosely coupled from any other webservice. The loyalty hub platform 10 includes a collection of microservices, each one self-contained and implementing a single and well defined business capability. Each service is a code base which can be managed by a small development team and does not need to share the same technology stack, library or frameworks, which allows each team to select the right tool for the job. This means, a single development team can build, deploy and test a service. These microservices provide a robust and scalable architecture for implementing the loyalty hub services on the platform 10.

The architecture shown in FIG. 2 assumes that customer linking with the loyalty partner system 22 is done at the customer level such that the loyalty partner membership is flagged to identify eligible customers and the loyalty partner system 22 can, based on this eligibility, give “accelerated” points on eligible purchases for all in-scope transaction cards offered by the enterprise system 16. Another assumption is that the loyalty hub databases store a customer's card level details. Also, the rewards accelerator can be enabled at the credit BoR by the loyalty hub platform 10 at the account level. The loyalty hub services includes microservices that include or are coupled to a representational state transfer (REST) application programming interface (API) 42. Each microservice also includes its own distinct database or separate and distinct portion of a wider platform services database. In this example, a registration service 38 includes or has access to a registration record 40, a redemption service 44 includes or has access to a redemption record 46, a preference/rule engine service 48 includes a preference record 50, a profile management service 52 includes a profile update record 54, an auto-redemption service 56 includes an auto-redemption record 58, and a lifecycle management (LCM) service 60 includes an LCM record 62. It can be appreciated that the auto-redemption service 56 can be omitted or otherwise not utilized by a loyalty partner system 22 or particular linkage with the enterprise system 16 if an automatic redemption option is not utilized.

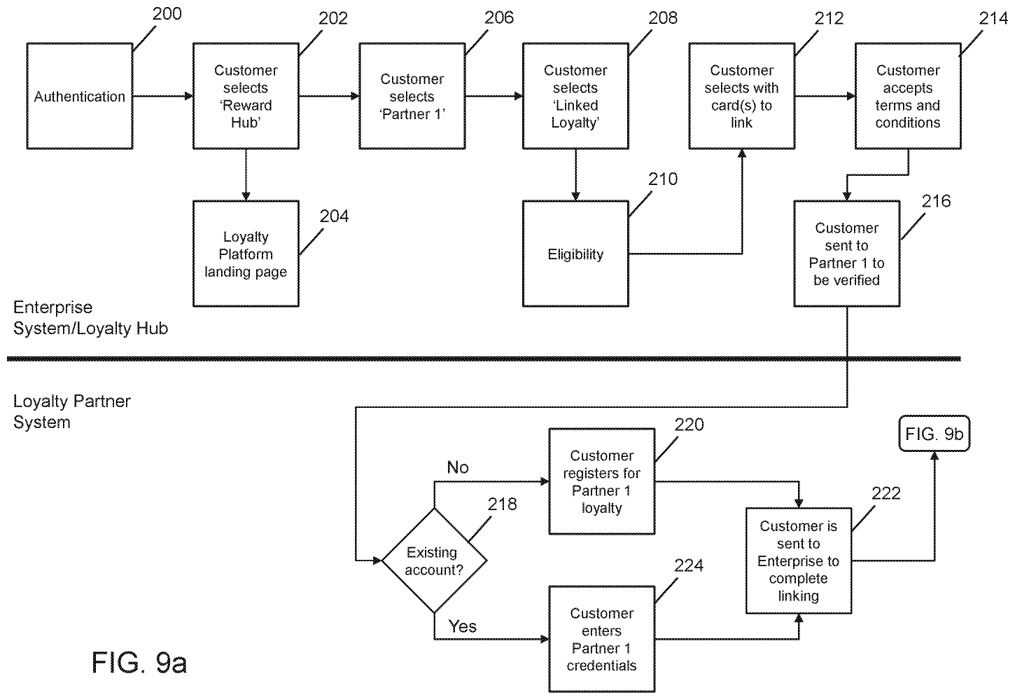

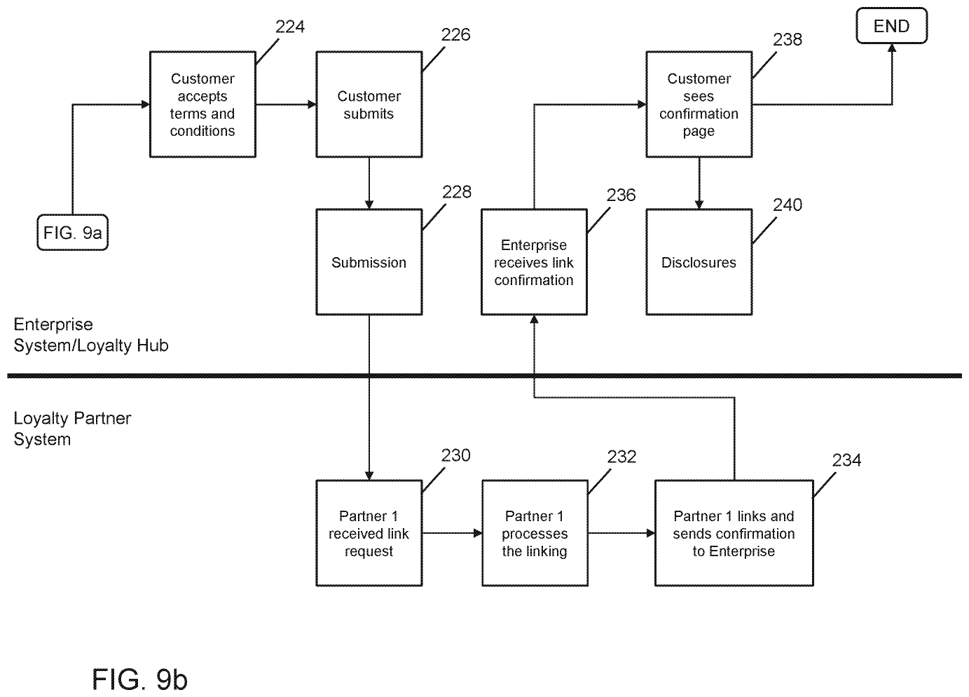

The registration service 38 fulfills a linked loyalty flow (see FIGS. 9a-9b described below) and is responsible for handling all orchestration required from the point that a customer 32 submits the linked loyalty flow on the enterprise system channel 30 onwards, including a call to the loyalty partner system 22 (e.g., restaurant, coffee chain, etc.). Functions of the registration service 38 can include recording a history of all customer registration activity in the registration record 40, activating the acceleration rate for the enterprise system credit cards, notifying the loyalty partner system 22 of customer activity at the customer level, updating the profile management service 52 (see below) when a customer links cards to a loyalty partner and when a customer unlinks cards from loyalty partners, and providing a history of all customer linking/unlinking activity with a loyalty partner.

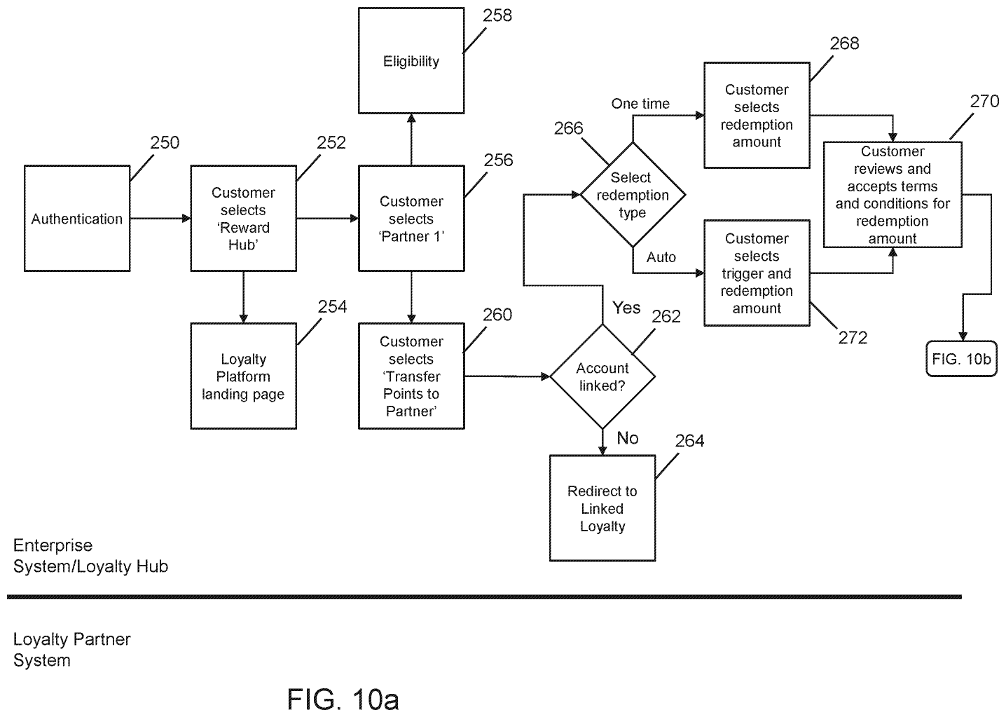

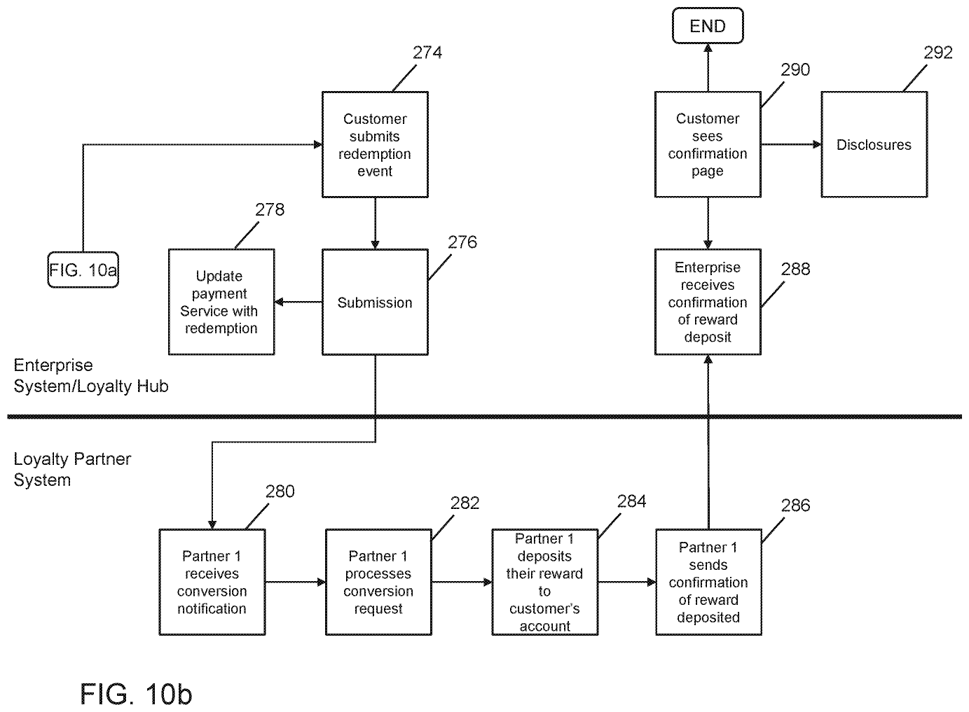

The redemption service 44 fulfills any transfer points to the loyalty partner (e.g., see flowchart in FIGS. 10a and 10b) and is responsible for handling all orchestration required from the point that a customer submits a one-time redemption through the enterprise system channel 30. The redemption service 44 can also process auto-redemption transactions. Functions of the redemption service 44 can include recording a history of all customer loyalty redemptions (transfer points to partner) in the redemption record 46, processing the enterprise system reward points redemption, notifying the loyalty partner of customer activity, and providing a history of all customer redemption activity with a loyalty partner.

The preference/rule engine service 48 maintains and validates loyalty hub business rules and is responsible for storing all of the business rules at a partner and card level for a loyalty program, e.g., in the preference record 50. The rule engine service 48 can also orchestrate the eligibility check of cards for linked loyalty and the transfer of points to partners (e.g., see FIGS. 9 and 10). Functions of the rule engine service 48 can also include providing an enterprise system card value proposition for each in-scope card with the loyalty partner (stored in the preferences record 50), providing the loyalty partner and program information (also stored in the preferences record 50), validating auto-redemption criteria stored in the preferences record 50, validating one-time redemption criteria stored in preferences record 50, running debit and credit card eligibility checks, and providing a list of loyalty hub frequently-asked questions (FAQs).

The profile management service 52 can be used to maintain a snapshot of the customer's linked enterprise system cards to loyalty partner(s) and can be made responsible for providing to the enterprise system channel(s) 30 the most up-to-date customer and loyalty partner linkage information. The profile management service 52 is also the gateway for customer eligibility for linked loyalty and transferring points to partners (see FIGS. 9-10). Functions of the profile management service 52 can include providing a list with cashback balances for each cashback product owned by the customer, providing a list with enterprise system rewards balances for each credit card product owned by the customer 32, providing a list of a customer's currently linked partners/products, providing a list of customer in-scope products for the loyalty partner, providing a list of customer eligible cards to transfer points to a partner or for auto-redemption, and providing rewards transactional histories.

The auto-redemption service 56 can be used to maintain and process customer auto-redemption details and is responsible for storing the most up-to-date customer auto-redemption instructions in the auto-redemption record 58, triggering the auto-redemption events, and orchestrating the required calls to perform same. Functions of the auto-redemption service 56 include time basing auto-redemption transactions, recording a history of all customer auto-redemption instructions, triggering auto-redemption events based on instructions, sending customer correspondence, updating the profile management service 52 (as noted above), processing enterprise system reward points redemptions, and notifying the loyalty partner of customer activity, e.g., which is delegated to the enterprise system's internal rewards/redemption service.

The LCM service 60 processes LCM events and is responsible for obtaining card event information for debit and credit card lifecycle updates and orchestrating calls to all impacted services. Functions of the LCM service 60 include processing credit card lifecycle events where a product transfer between eligible cards of the same reward takes place, processing credit card where a product transfer between eligible cards of different reward takes place, processing credit card lifecycle events where a credit card is closed, processing credit card lifecycle events where a debit card is closed, processing debit card lifecycle events where new card numbers are generated, processing credit card lifecycle events where new card numbers are generated, and processing customer new card openings.

The core microservices shown in FIG. 2 enable the loyalty partner systems 22 and the enterprise system 16 to link loyalty programs providing the flexibility to convert, transfer and/or accelerate points between programs. The individual microservices operate dynamically as described below based on event processing. This facilitates interface requests, integration actions through a common backend hub. The orchestration of the microservices by the loyalty hub platform 10 also ensures that the correct microservices are called as well as integrating inbound and outbound traffic with both the loyalty partner systems 22 and the payment systems 34 used to trigger the loyalty events. This arrangement avoids batch processing, which is more dynamic and allows one microservice to respond to an event (e.g., registration) even when another service is in a failure state (e.g., redemption or profile management, etc.). The independent services also enable customization on a partner-basis. For example, one loyalty partner system 22 may allow auto-redemption while others do not and the auto-redemption service 56 can be assigned to different loyalty partner systems 22 individually. Moreover, the microservice architecture allows additional microservices to be added, e.g., to add new features or offerings by the enterprise system 16 or loyalty partner system(s) 22 on a permanent or temporary basis such as to handle promotional campaigns, etc. The incorporation of a preference/rule engine service 48 also enables individual rule sets to be applied and updated periodically on a partner-by-partner basis to avoid downtime when updating or upgrading linked loyalty campaigns.

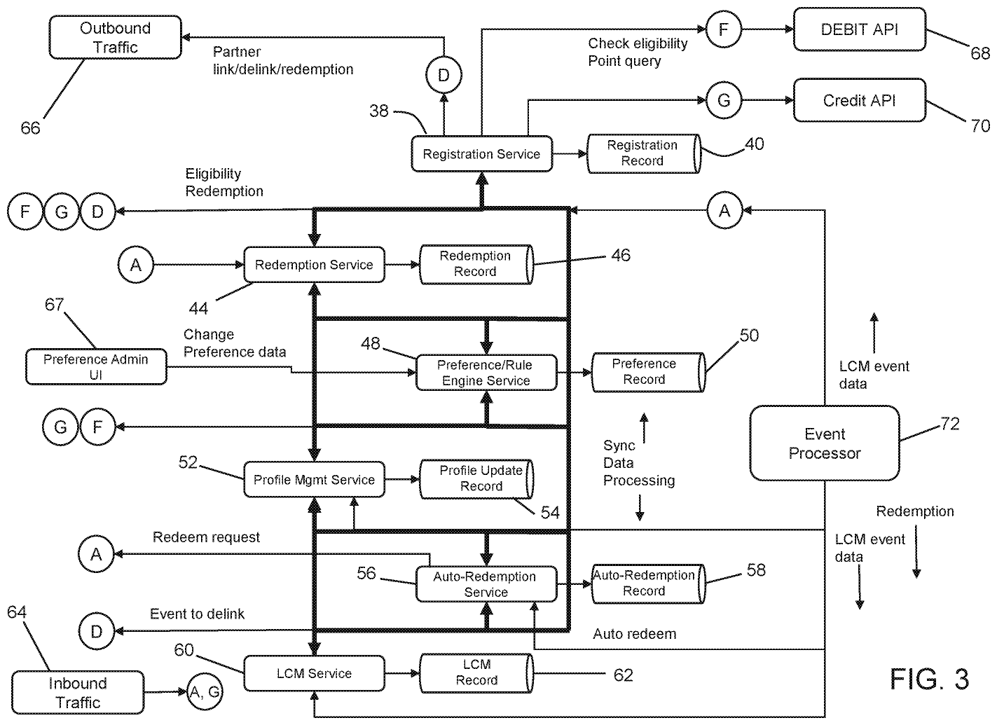

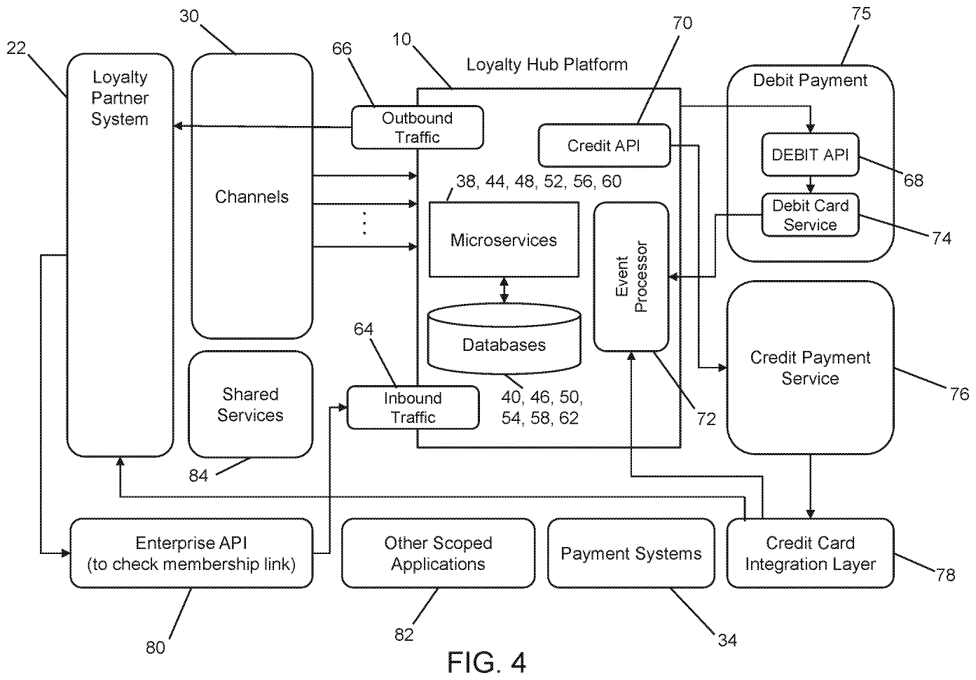

FIG. 3 illustrates the synchronous communication of the microservices 38, 44, 48, 52, 56, 60 and orchestration with each other. In this configuration, a service calls a REST API 42 that another service exposes, and the caller waits for a response from the receiver. In FIG. 3, an inbound traffic service 64 is shown, which can take the form of a service, microservice, API or other interface mechanism. The inbound traffic service 64 handles inbound data from the loyalty partner system(s) 22 via an enterprise API 80 (see also FIG. 4). Similarly, an outbound traffic service 66 is provided, which can take the form of a service, microservice, API or other interface mechanism. The outbound traffic service 66 handles data that is sent back to the loyalty partner system(s) 22 via the enterprise channel(s) 30 such as via a mobile or web application. An event processor 72 is also shown, which monitors events from the payment systems 34, such as debit or credit transactions with cards that may be associated with the linked loyalty programs.

The event processor 72 can be implemented as a module or device comprising a processor, a memory that stores computer executable instructions, and a communication module; or can utilize processing, memory, and communication capabilities provided by the loyalty hub platform 10. As discussed in greater detail below, the event processor 72 can monitor transaction events in order to detect when card numbers masked by a payment system or payment provider (e.g., PayPal®) account number are associated with loyalty programs. In this way, the event processor 72 can decouple transactions from the loyalty hub platform 10 and perform a mapping on behalf of payment services and payment providers, where necessary, to ensure that loyalty-related actions or events can be triggered by the use of a payment card or payment account, e.g., one issued by the enterprise system 16 (e.g., a financial institution).

In FIG. 3, data received at the inbound traffic service 64 as well as events detected by the event processor 72 (e.g., LCM event data) flows to point A, which is read by the microservices, including the redemption service 44. Redeem requests also flow to point A. Data received at the inbound traffic service 64 may also flow to point G, which along with other outputs from the microservices flow to a credit API 70 (e.g., TSYS) to be communicated to a credit card payment system 34. Similarly, various events such as eligibility redemptions can flow to point F, to be communicated to a debit card payment system via a debit API 68. Delinking events, eligibility redemption and other events may also flow to point D, which feeds the outbound traffic service 66 to communicate events back to the associated loyalty partner system 22. A preference admin UI 67 can also be integrated as shown, to enable preference data to be changed. As can be appreciated from FIG. 3, the individual microservices and corresponding database records can be used to dynamically handle events both synchronously and asynchronously. In this way, multiple loyalty partner systems 22 can be integrated into the loyalty hub platform 10 independently without requiring batch processing or being susceptible to failovers and outages on one particular service.

FIG. 4 provides an architectural configuration for the loyalty hub platform 10 to illustrate the integration with a loyalty partner system 22, a debit payment service 75, and a credit payment service 76 (e.g., TSYS). The debit and credit payment services 75, 76 are coupled to the event processor 72 in the loyalty hub platform 10 to enable the platform 10 to detect payment and other transaction events. Also shown in FIG. 4 is a credit card integration layer 78 and the payment systems 34 such as Interac®, Visa®, Mastercard®, etc. The architecture in FIG. 4 also enables other scoped applications 82 to be integrated with the services orchestrated by the loyalty hub platform 10. An enterprise API 80 is also shown, which provides a merchant application or other service within a loyalty partner system 22 to check membership links with the loyalty hub platform 10. The enterprise channels 30 and shared services 84 (e.g., knowledge management systems) an also integrate the loyalty partner systems 22 with the loyalty hub platform 10.

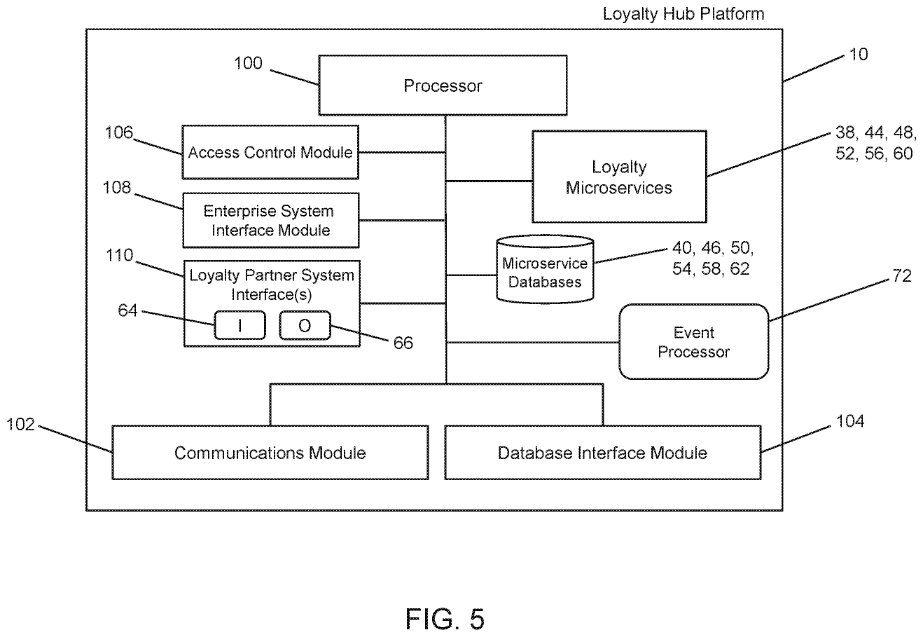

In FIG. 5, an example configuration for the loyalty hub platform 10 is shown. In certain embodiments, the loyalty hub platform 10 may include one or more processors 100, a communications module 102, and a database interface module 104 for interfacing with the datastore of transaction data 20 (and if permitted client data 18) to retrieve, modify, and store (e.g., add) data. Communications module 102 enables the loyalty hub platform 10 to communicate with one or more other components of the computing environment 8, such as client device 12 (or one of its components), via a bus or other communication network, such as the communication network 14. While not delineated in FIG. 5, the loyalty hub platform 10 includes at least one memory or memory device that can include a tangible and non-transitory computer-readable medium having stored therein computer programs, sets of instructions, code, or data to be executed by processor 100. FIG. 5 illustrates examples of modules, tools and engines stored in memory on the loyalty hub platform 10 and operated or executed by the processor 100. It can be appreciated that any of the modules, tools, and engines shown in FIG. 5 may also be hosted externally and be available to the loyalty hub platform 10, e.g., via the communications module 102. In the example embodiment shown in FIG. 5, the loyalty hub platform 10 includes an access control module 106, an enterprise system interface module 108, one or more loyalty partner system interfaces 110, e.g., the inbound traffic service (I) 64 and outbound traffic service (O) 66 described above; the loyalty microservices 38, 44, 48, 52, 56, 60 described above, the microservice databases 40, 46, 50, 54, 58, 62 described above, and the event processor 72 that, as discussed above, enable the loyalty hub platform 10 to orchestrate linked loyalty operations asynchronously while minimizing interruptions and failovers.

The access control module 106 may be used to apply a hierarchy of permission levels or otherwise apply predetermined criteria to determine what client data 18, transaction data 20, or financial data 148 can be shared with which entity in the computing environment 8. For example, the loyalty hub platform 10 may have been granted access to certain sensitive client data 18 or financial data 148 for a user, which is associated with a certain client device 12 in the computing environment 8. Similarly, certain client profile data stored in the client data 18, transaction data 20, or financial data 148 may include potentially sensitive information such as age, date of birth, or nationality, which may not necessarily be needed by the loyalty hub platform 10 to execute certain actions. As such, the access control module 106 can be used to control the sharing of certain client profile data or other transaction data and/or transaction data 20 and/or financial data 148 based on a type of client/user, a permission or preference, or any other restriction imposed by the computing environment 8 or application in which the loyalty hub platform 10 is used.

The enterprise system interface module 108 can provide a graphical user interface (GUI), software development kit (SDK) or API connectivity to communicate with the enterprise system 16 to obtain client data 18, transaction data 20 and financial data 148 for a certain user (see FIG. 7). It can be appreciated that the enterprise system interface module 108 may also provide a web browser-based interface, an application or “app” interface, a machine language interface, etc.

The loyalty partner system interface(s) 110 can include any interface, service, API, SDK, plug-in or other software module that can be used to interface the enterprise system 16 with the loyalty partner system(s) 22, including the inbound traffic service (I) 64 and the outbound traffic service (O) 66.

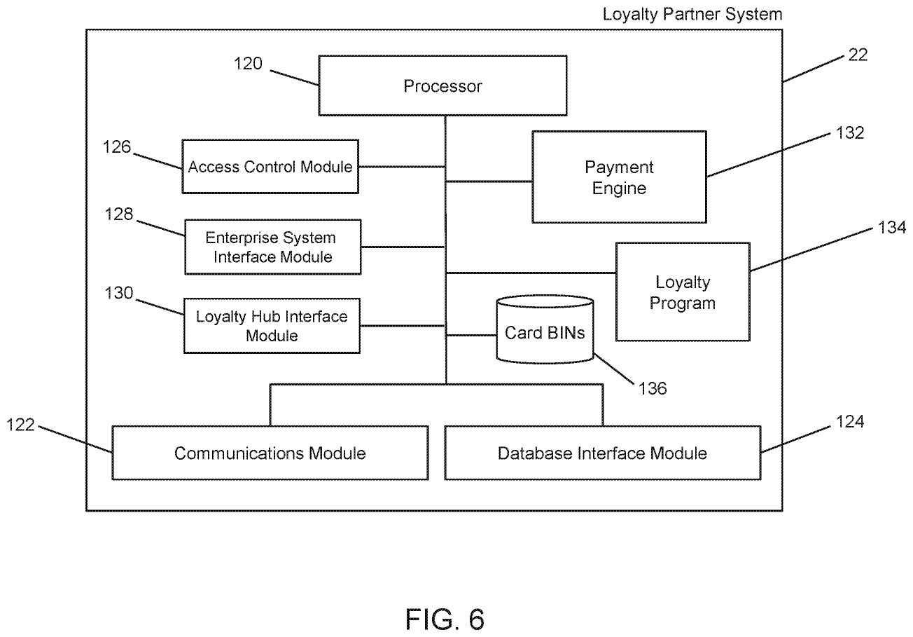

In FIG. 6, an example configuration for a loyalty partner system 22 is shown. In certain embodiments, the loyalty partner system 22 may include one or more processors 120, a communications module 122, and a database interface module 124 for interfacing with the datastore of transaction data 20 (and if permitted client data 18) to retrieve, modify, and store (e.g., add) data. Communications module 122 enables the loyalty partner system 22 to communicate with one or more other components of the computing environment 8, such as client device 12 (or one of its components), via a bus or other communication network, such as the communication network 14. While not delineated in FIG. 6, the loyalty partner system 22 includes at least one memory or memory device that can include a tangible and non-transitory computer-readable medium having stored therein computer programs, sets of instructions, code, or data to be executed by processor 120. FIG. 6 illustrates examples of modules, tools and engines stored in memory on the loyalty partner system 22 and operated or executed by the processor 120. It can be appreciated that any of the modules, tools, and engines shown in FIG. 6 may also be hosted externally and be available to the loyalty partner system 22, e.g., via the communications module 122. In the example embodiment shown in FIG. 6, the loyalty partner system 22 includes an access control module 126, an enterprise system interface module 128, a loyalty hub interface module 130, a payment engine 132, a loyalty program 134 a sub-system or service associated with a loyalty program provided by the loyalty partner system 22), and a datastore for storing a set of card BINs 136 for linked loyalty allocations.

The access control module 126 may be used to apply a hierarchy of permission levels or otherwise apply predetermined criteria to determine what client data 18, transaction data 20, or financial data 148 can be shared with which entity in the computing environment 8. For example, the loyalty partner system 22 may have been granted access to certain sensitive client data 18 or financial data 148 for a user, which is associated with a certain client device 12 in the computing environment 8. Similarly, certain client profile data stored in the client data 18, transaction data 20, or financial data 148 may include potentially sensitive information such as age, date of birth, or nationality, which may not necessarily be needed by the loyalty hub platform 10 to execute certain actions. As such, the access control module 126 can be used to control the sharing of certain client profile data or other transaction data and/or transaction data 20 and/or financial data 148 based on a type of client/user, a permission or preference, or any other restriction imposed by the computing environment 8 or application in which the loyalty partner system 22 is used.

The enterprise system interface module 128 can provide a GUI, SDK or API connectivity to communicate with the enterprise system 16 to obtain client data 18, transaction data 20 and financial data 148 for a certain user (see FIG. 7). It can be appreciated that the enterprise system interface module 128 may also provide a web browser-based interface, an application or “app” interface, a machine language interface, etc.

The loyalty hub interface module 130 enables the loyalty partner system 22 to interface with the loyalty hub platform 10 by connecting to the enterprise API 80 and/or the inbound traffic service 64 and/or the outbound traffic service 66 and/or the enterprise communication channels 30 by accessing and utilizing the communications module 122. The loyalty partner system 22 also includes a payment engine 132 for processing merchant payments associated with an enterprise providing the partnered loyalty program (e.g., restaurant, coffee chain, retail store, etc.). The loyalty partner system 22 can also have a separate loyalty program 134 that operates independently of the loyalty hub platform 10 but can be linked to the enterprise system 16 via the enterprise system and/or loyalty hub interface modules 128, 130. The loyalty partner system 22 in this example includes a datastore for storing card BINs 136 to enable the loyalty partner system 22 to apply acceleration points at the point of sale (e.g., via the payment engine 132) when a linked loyalty customer uses a payment card provided by the enterprise system 16 that has been linked to the loyalty program 134.

In FIG. 7, an example configuration of the enterprise system 16 is shown. The enterprise system 16 includes a communications module 140 that enables the enterprise system 16 to communicate with one or more other components of the computing environment 8, such as client device 12 (or one of its components), loyalty partner system(s) 22, or loyalty hub platform 10, via a bus or other communication network, such as the communication network 14. While not delineated in FIG. 7, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 7 illustrates examples of servers and datastores/databases operable within the enterprise system 16.

It can be appreciated that any of the components shown in FIG. 7 may also be hosted externally and be available to the enterprise system 16, e.g., via the communications module 140. In the example embodiment shown in FIG. 7, the enterprise system 16 includes one or more servers to provide access to the client data 18 (which may be included with the financial data 148 or stored separately as shown in FIG. 1) and the transaction data 20, to the loyalty hub platform 10, to enable the loyalty hub platform 10 to interface with one or more loyalty partner systems 22 to provide a hub for linking loyalty programs as described above. Exemplary servers include a mobile application server 142, a web server 146 and a data server 150. Although not shown in FIG. 7, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storages for storing and providing data for use in such services, such as data storage for storing financial data 148.

Mobile application server 142 supports interactions with a mobile application installed on client device 12. Mobile application server 142 can access other resources of the enterprise system 16 to carry out requests made by, and to provide content and data to, a mobile application on client device 12. In certain example embodiments, mobile application server 142 supports a mobile banking application. As shown in FIG. 7, the mobile application server 142 can include a loyalty API 144 which enables the mobile application to integrate or otherwise coordinate or work with the loyalty hub platform 10. For example, the loyalty API 144 can communicate with the loyalty hub platform 10 via the enterprise system integration module 108 in the loyalty hub platform 10 (see FIG. 5).

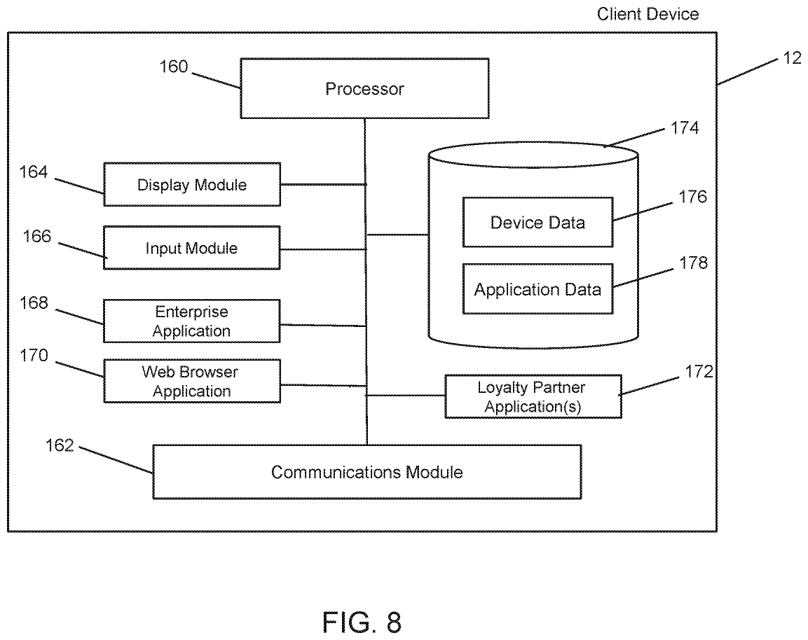

Web application server 146 supports interactions using a website accessed by a web browser application 170 (see FIG. 8) running on the client device 12. It can be appreciated that the mobile application server 142 and the web application server 146 can provide different front ends for the same application, that is, the mobile (app) and web (browser) versions of the same application. For example, the enterprise system 16 may provide a banking application that be accessed via a smartphone or tablet app while also being accessible via a browser 170 on any browser-enabled device. As shown in FIG. 7, the web application server 146 may also include a loyalty API 144 to enable the web application to integrate or otherwise coordinate or work with the loyalty hub platform 10.

The financial data 148 may be associated with users of the client devices 12 (e.g., customers of a financial institution). The financial data 148 may include any data related to or derived from financial values or metrics associated with customers of the enterprise system 16, for example, account balances, transaction histories, line of credit available, credit scores, mortgage balances, affordability metrics, investment account balances, investment values and types, insurance policies, insurability metrics, among many others. Other metrics can be associated with the financial data 148, such as financial health data that is indicative of the financial health of the users of the client devices 12. As indicated above, it can be appreciated that the client data 18 shown in FIG. 1 may include or be part of the financial data 148 held by the enterprise system 16 and is shown separately for ease of illustration and ease of reference herein.

In FIG. 8, an example configuration of the client device 12 is shown. In certain embodiments, the client device 12 may include one or more processors 160, a communications module 162, and a data store 174 storing device data 176 and application data 178. Communications module 162 enables the client device 12 to communicate with one or more other components of the computing environment 8, such as loyalty hub platform 10, loyalty partner system(s) 22, or enterprise, system 16, via a bus or other communication network, such as the communication network 14. While not delineated in FIG. 8, the client device 12 includes at least one memory or memory device that can include a tangible and non-transitory computer-readable medium having stored therein computer programs, sets of instructions, code, or data to be executed by processor 160. FIG. 8 illustrates examples of modules and applications stored in memory on the client device 12 and operated by the processor 160. It can be appreciated that any of the modules and applications shown in FIG. 8 may also be hosted externally and be available to the client device 12, e.g., via the communications module 162.

In the example, embodiment shown in FIG. 8, the client device 12 includes a display module 164 for rendering GUIs and other visual outputs on a display device such as a display screen, and an input module 166 for processing user or other inputs received at the client device 12, e.g., via a touchscreen, input button, transceiver, microphone, keyboard, etc. The client device 12 may also include an enterprise application 168 provided by the enterprise system 16, e.g., for performing mobile banking, investing, or other financial product or services. The client device 12 in this example embodiment also includes a web browser application 170 for accessing Internet-based content, e.g., via a mobile or traditional website and one or more loyalty partner applications 172, e.g., to access, view, redeem, transfer, or convert rewards provided by the corresponding loyalty partner system 22. The data store 174 may be used to store device data 176, such as, but not limited to, an IP address or a MAC address that uniquely identifies client device 12 within environment 8. The data store 176 may also be used to store application data 178, such as, but not limited to, login credentials, user preferences, cryptographic data (e.g., cryptographic keys), etc.

It will be appreciated that only certain modules, applications, tools and engines are shown in FIGS. 2 to 8 for ease of illustration and various other components would be provided and utilized by the loyalty hub platform 10, loyalty partner system(s) 22, enterprise system 16, and client device 12, as is known in the art.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in loyalty hub platform 10 or enterprise system 16, or client device 12, or accessible or connectable thereto. Any application or module herein described may be implemented using computer readable/executable instructions that may be stored or otherwise held by such computer readable media.

Turning now to FIGS. 9a and 9b, a flow diagram is provided to illustrate linking loyalty programs via the loyalty hub platform 10. Beginning with FIG. 9a, after an authentication operation at 200 the customer selects a Reward Hub option, tab, page, etc. at 202 which brings them to a Loyalty Platform landing page at 204. The customer can then select a loyalty partner, in this example Partner 1 at 206 and select an option to enable Linked Loyalty at 208. This generates an eligibility list at 210, e.g., of payment and credit cards that are eligible for linked loyalty, allowing the customer to select the card(s) to link at 212. The customer can then accept terms and conditions at 214 (and/or any additional operations required to move forward) and the customer is navigated to Partner 1 to be verified by connecting into the associated loyalty partner system 22. At the loyalty partner system 22, the loyalty partner determines at 218 if the customer has an existing account with them. If not, the customer is registered for Partner 1's loyalty program at 220. If the customer is registered, the customer is asked to enter their credentials at 224. The customer is then sent to the enterprise system 16 or loyalty hub platform 10 to complete the linking as shown in FIG. 9b.

Referring now to FIG. 9b, at the enterprise system 16 or loyalty hub platform 10 the customer accepts terms and conditions at 224 and selects a submit option at 226. This results in a submission made at 228 back to the loyalty partner system 22. At 230 Partner 1 receives a link request and processes the linking operation at 232. Partner 1 then links the loyalty accounts and sends a confirmation to the enterprise at 234, e.g., by communicating with the enterprise system 16 or loyalty hub platform 10. At 236 the enterprise receives the link confirmation and displays a confirmation page to the customer 32 at 238. At 240 a disclosures operation can be performed, e.g., to make any necessary disclosures to the customer 32.

FIGS. 10a and 10b provide a flow diagram for transferring loyalty points to a loyalty partner. Referring first to FIG. 10a, after an authentication operation at 250 the customer selects a Reward Hub option, tab, page, etc. at 252 which brings them to a Loyalty Platform landing page at 254. The customer can then select a loyalty partner, in this example Partner 1 at 256, which calls an eligibility process at 258 to determine the customer's eligibility to transfer loyalty points. At 260 the customer selects a “Transfer Points to Partner” option, which causes the loyalty hub platform 10 to determine if the account is linked with that partner loyalty program at 262. If not, the customer 32 is redirected to the linked loyalty flow in FIGS. 9a and 9b at 264. If the customer 32 is linked to that partner, the customer can select a redemption type at 266. In this example, the redemption types can include one time or automatic (auto) redemption. If selecting a one time redemption the customer selects the redemption amount at 268. If the selecting an auto redemption the customer selects a trigger and the redemption amount when that trigger is detected at 272. The customer then reviews and accepts any terms and conditions for the redemption amount at 270 and the process proceeds to FIG. 10b.

Referring now to FIG. 10b, the customer submits the redemption event at 274 and the submission is made at 276 causing the payment service (e.g., TSYS) to be updated with the redemption amount at 278. Partner 1 then receives a conversion notification at 280 and processes the conversion request at 282. Partner 1 then deposits the reward to the customer's account in their loyalty program at 284 and sends a confirmation of reward deposited to the loyalty hub platform 10 at 286. The enterprise (e.g., at loyalty hub platform 10) receives the confirmation at 288 and the confirmation page is displayed to the customer at 290. At 292 a disclosures operation can be performed, e.g., to make any necessary disclosures to the customer 32.

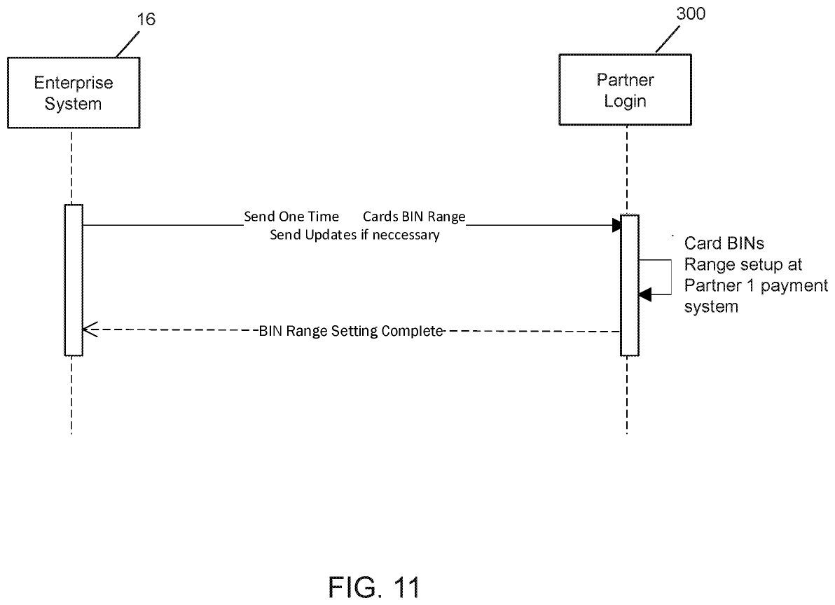

FIG. 11 is a sequence diagram illustrating a payment card number provisioning process between the enterprise system 16 and a partner login portal 300 used by the loyalty partner system 22 to obtain BINs for payment cards issued by the enterprise system 16. It can be appreciated that the enterprise system 16 can have the process shown in FIG. 11 implemented by the loyalty hub platform 10, including by the event processor 72, which is used to monitor transaction events. In this example, the enterprise system sends a one time card BIN range (i.e., a range of values corresponding to a block of BINs for cards that are associated with the enterprise system 16). This channel can also be used to send updates to the BIN range(s) if necessary. The loyalty partner login 30 initiates a process to setup the card BINs range at the Partner 1 payment system so that the cards can be recognized if being identified within that BIN range. The partner login 300 connection can also be used to send a confirmation that the BIN range setting is complete.

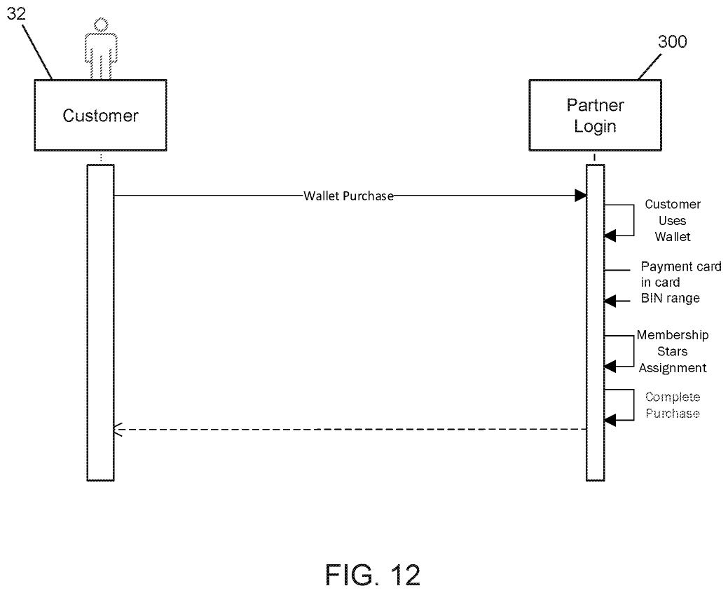

FIG. 12 is a sequence diagram illustrating a linked loyalty points assignment process during a transaction. In this example a customer 32 connects to the partner login 300 and uses their mobile wallet. The partner login 300 checks to see if the payment card being used (in this case an electronic version of a payment card) is in the BIN range setup as shown in FIG. 11. If the payment card is identified, the membership stars (or other loyalty reward) assignment is made according to the terms of the linked loyalty. For example, using the payment card provided by the enterprise system 16 may lead to an acceleration of points that would normally be rewarded by Partner 1. The purchase is then completed as usual, and the customer obtains the goods/services from Partner 1 while having the linked loyalty reward(s) applied by Partner 1. As discussed further below, to account for situations where the payment source cannot be mapped by the merchant to a payment card in the BIN range (e.g., a card masked within a PayPal® account), the event processor 72 can detect the transaction events via a connection to the payment systems as illustrated herein, to map such masked transactions to payment cards that are in the BIN range or are otherwise eligible for a loyalty-related action such as the acceleration of points as shown in FIG. 12.

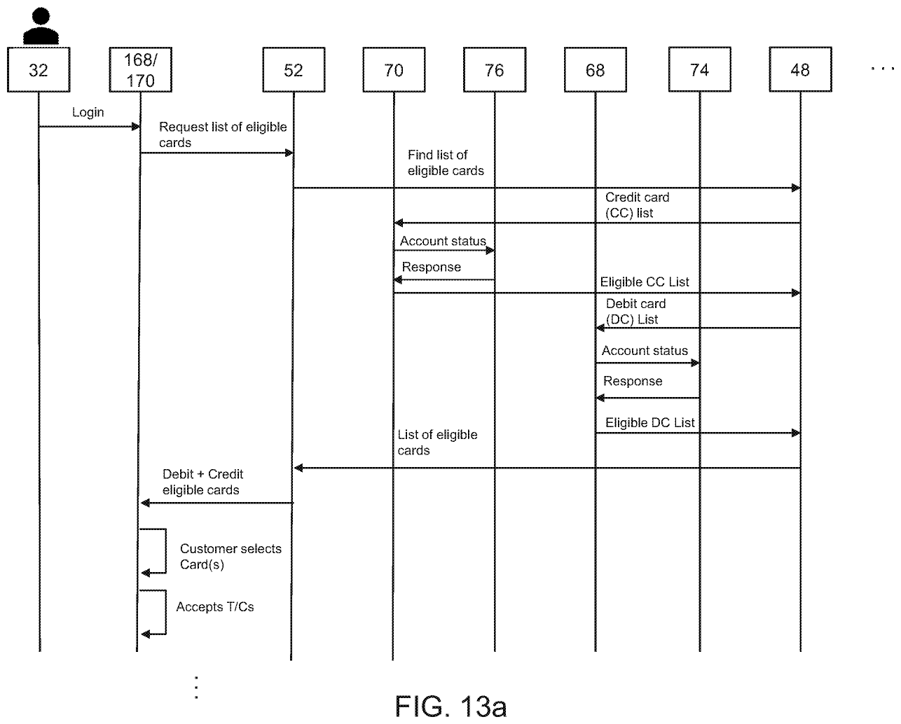

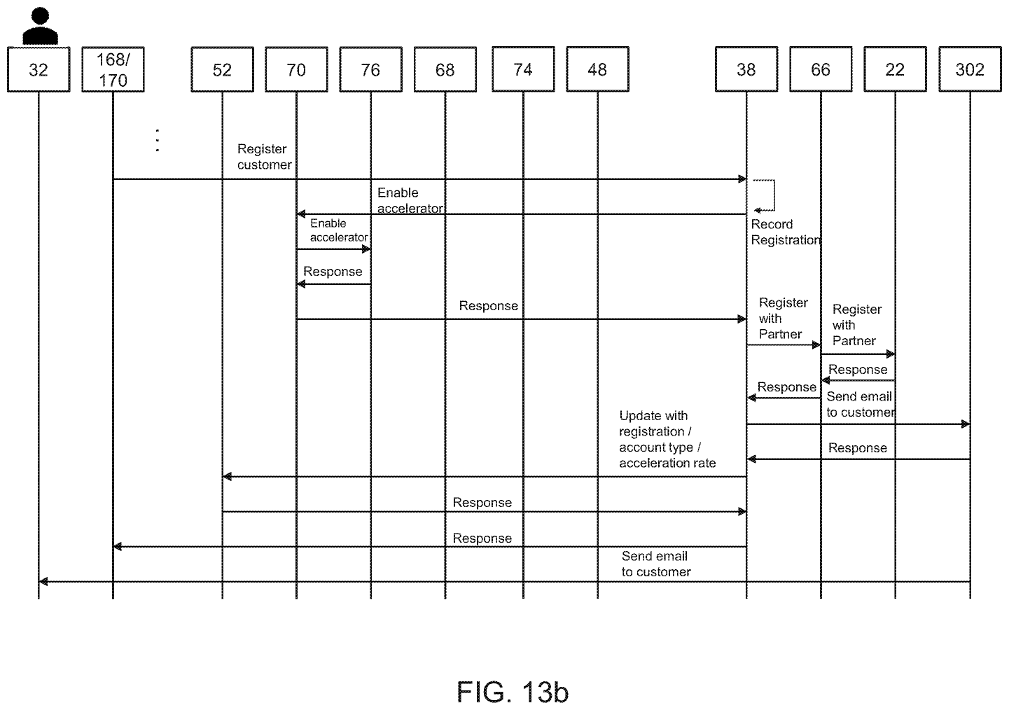

FIGS. 13a and 13b provide a sequence diagram illustrating eligibility and registration processes. The customer 32 logs in via the enterprise application 168 or web browser application 170 and requests a list of eligible cards that is sent to the profile management service 52, which communicates with the preference/rule engine service 48 to find the list of eligible cards. A credit card list is returned to the credit API 70, which checks the account status with the credit card service 76. The credit card service 76 returns a response. The credit API 70 sends the eligible credit card list to the preference/rule engine service 48. The preference/rule engine service 48 then returns a list of eligible debit cards to the debit API 68, which determines the account status from the debit card service 74. The debit card service 74 returns a response to the debit API 68, which then sends the eligible debit card list to the preference/rule engine service 48. A complete list of eligible cards is then returned to the profile management service 52, which relays this information to the application 168/170. The customer can then select the card(s) it desires to link and accepts the terms and conditions (T/C).

Referring now to FIG. 13b, the flow continues into a registration phase. Via the application 168/170 a register customer request is sent to the registration service 38, which records the registration and returns an accelerator enablement message to the credit API 70. The credit API 70 enables the accelerator by communicating with the credit payment service 76, which returns a response to the credit API 70. The credit API 70 relays this response to the registration service 38, which registers with the partner by communicating with the outbound traffic service 66. The outbound traffic service 66 communicates the registration request with the loyalty partner system 22, which returns a response to the outbound traffic service 66 which is relayed to the registration service 38. The registration service 38 initiates the sending of an email to the customer 32 by communicating with a messaging service 302 used by the loyalty partner system 22. The messaging service 302 returns a response to the registration service 38, which updates the profile management service 52 with the registration, account type and acceleration rate for the customer 32. A response is sent to the registration service 38, which is relayed back to the application 168/170. The email is also sent to the customer 32 by the messaging service 302.

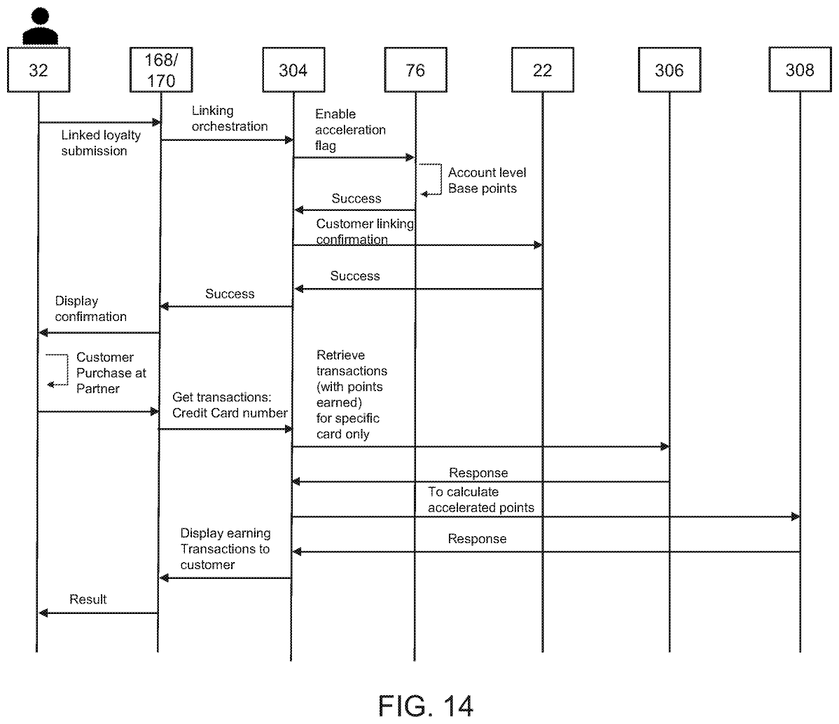

FIG. 14 is a sequence diagram illustrating a transaction history retrieval process. The customer 32 triggers a linked loyalty submission via the application 168/170, which initiates a linking orchestration by communicating with a profile manager 304. The profile manager 304 enables a loyalty acceleration flag by communicating with the credit card service 76. The credit card service 76 sets an account level base points and returns a success message to the profile manager 304, which is relayed back to the application 168/170 and displayed to the customer 32. The customer 32 then makes a purchase at the Partner (having the Partner loyalty program) either then or at a later time and the application 168/170 submits a get transactions associated with the credit card number used in this example. The transactions are retrieved by communicating with a private server 306 behind or within the loyalty partner system 22. A response is returned to the profile manager 304. The profile manager 304 then sends a request to a preference manager 308 to calculate the accelerated points and a response is provided to the profile manager 304. The profile manager 304 displays the transactions that earned point to the customer 32 via the application 168/170 providing a result to the customer 32.

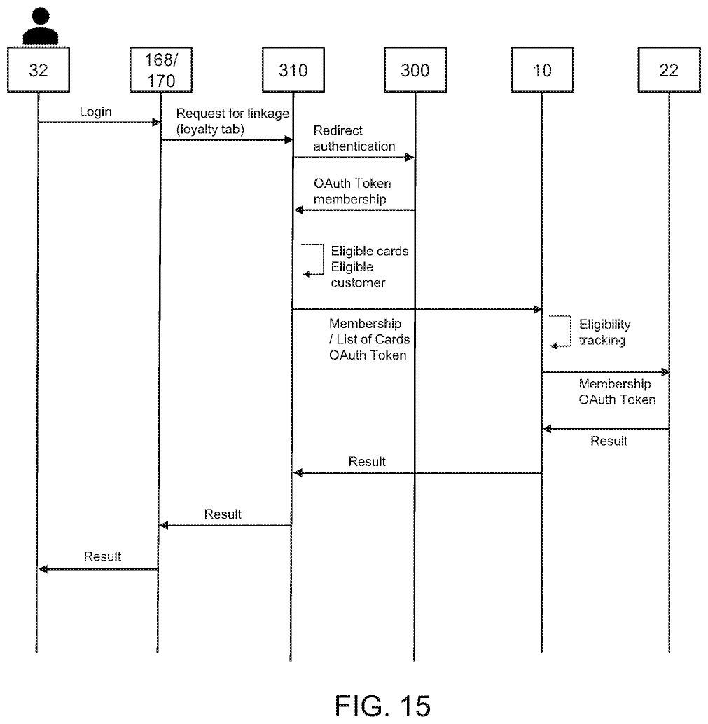

FIG. 15 is a sequence diagram illustrating a partner registration process. In this example the customer 32 logs into the application 168/170 and requests that a payment card be linked to a loyalty partner. The application 168/170 communicates this request to an account linking request service 310, which redirects the authentication to the partner login portal 300. An OAuth token membership is returned with eligible cards and eligible customers being determined at the account linking request service 310. The membership, the list of cards, and the OAuth token are then sent to the loyalty hub platform 10 to perform eligibility tracking. The loyalty hub platform 10 sends the membership data and OAuth token to the loyalty partner system 22, which returns a result. The result is then passed back to the customer 32 via the loyalty hub platform 10, account linking request service 310 and application 168/170.

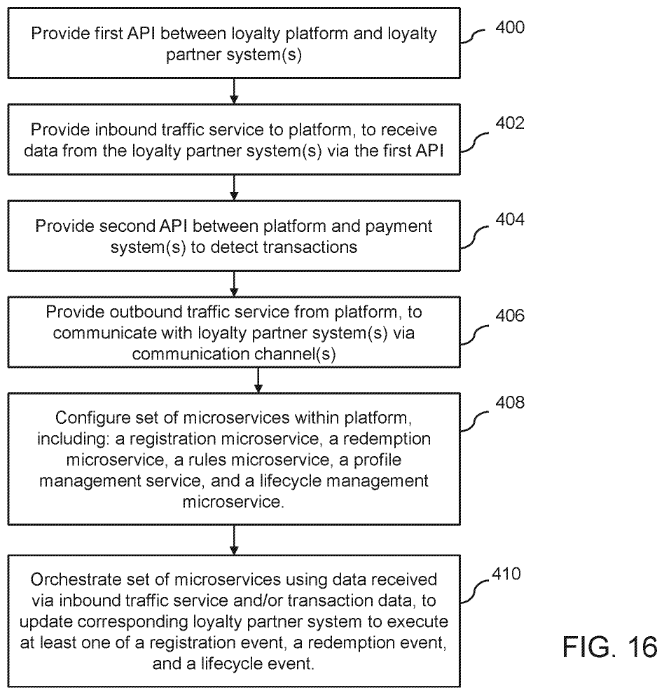

Referring to FIG. 16, an example embodiment of computer executable instructions for integrating loyalty program partner systems with an enterprise system is shown. At block 400, a first API is provided between the loyalty hub platform and the loyalty partner system(s) 22, e.g., by providing the enterprise API 80 and/or one or more communication channels 30. At 402, an inbound traffic service 64 is provided to the platform 10, to receive data from the loyalty partner system(s) 22 via the first API. At 404, a second API is provided between the loyalty hub platform 10 and at least one payment system 34, 75, 76, e.g., by providing the debit API 68 and/or credit API 70.

At 406, the outbound traffic service 66 is provided from the platform 10 to communicate with the loyalty partner system(s) 22 via the one or more communication channels 30 such as a mobile or web-based application 168/170. The loyalty hub platform 10 also configures a set of microservices at 408. These microservices include, as discussed above, a registration service 38, a redemption service 44, a preference/rules engine service 48, a profile management service 52, and a lifecycle management (LCM) service 60. With these services configured, the loyalty hub platform 10 can orchestrate the set of microservices at 410, using data received via the inbound traffic service 64 and/or transaction data (e.g., detected via transaction events), to update the corresponding loyalty partner system 22 to execute at least one of a registration event, a redemption event, and a lifecycle management event.

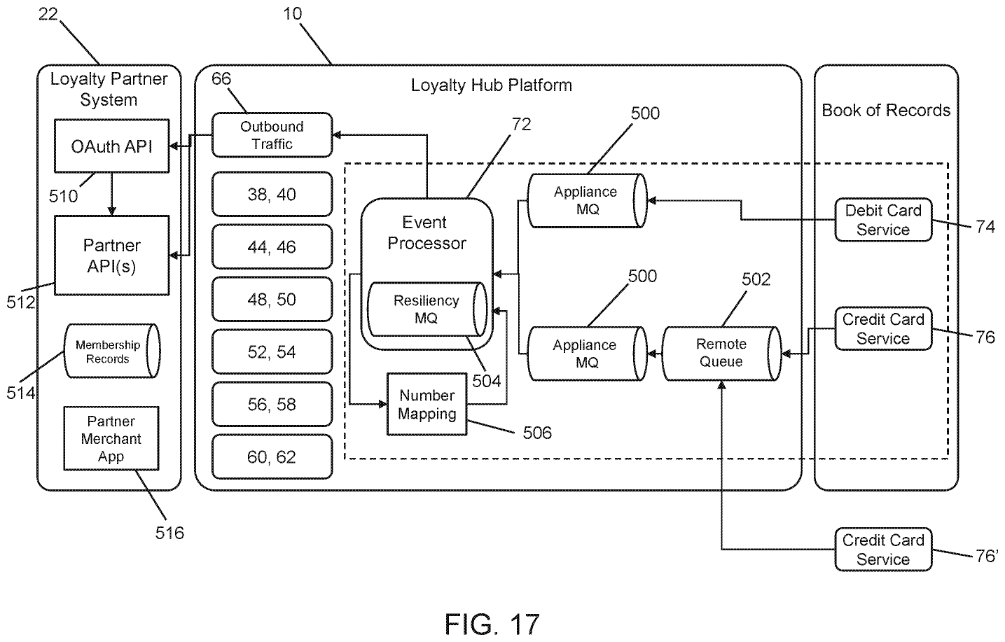

Turning now to FIG. 17, a configuration for integrating and coupling the event processor 72 to/with payment systems 74, 76 is shown. As discussed above, the event processor 72 can implement an event-driven transaction flow wherein by listening for and detecting events associated with transactions, the event processor 72 can, among other things, determine if a payment should have triggered a loyalty-related action but the payment card was masked by the payment service. This can occur, for example, by employing third party payment services such as PayPal®, Apple Pay®, and Samsung Pay® to name a few. In this example configuration, the event processor 72 is coupled to the book of records provided by the payment services. In this example, the debit card service 74 and credit card service 76 associated with the enterprise system 16 are coupled to the event processor 72 via appliance message queues (MQs) 500. The credit card service 76 and an external credit card service 76′ are coupled to an application MQ 500 via a remote queue 502. The MQs 500 and remote queue 502 can be used to capture and hold events that can be persisted or accessed ephemerally. The event processor 72 can also include a resiliency MQ 504 to hold its own copy of messages and events that are gathered by the MQs 500 in order to listen for transaction events.

The event processor 72 can also have access to a number mapping 506 module, list, storage data structure or other element that enables the event processor 72 to cross-reference transaction events with underlying payment card numbers. For example, when the event processor 72 can detect that a certain type of transaction event was made using a third party payment service that masks one or more payment cards, it can use an internally-held mapping to determine the payment card which would otherwise be masked from the loyalty partner at the point of sale. In this way, the event processor 72 can use its event-driven configuration to identify when certain loyalty-related actions should be applied. For example, if a user makes a purchase using the third party service, which ultimately gets applied to an eligible payment card, when that card is linked to a loyalty partner system 22, the user can be awarded the points or other redemption actions without the need to manually seek a redemption at a later time. Since users often make many transactions on a weekly or daily basis, avoiding the need to track which eligible purchases may not have been detected by a loyalty partner can avoid additional manual efforts as well as potentially tying up customer service channels at a cost to potentially both the enterprise system 16 and the loyalty partner system 22.

The event processor 72 is coupled to the outbound traffic module 66 and the microservices, as discussed in greater detail above, to enable the event processor 72 to communicate with the loyalty partner system 22 to notify it of the use of eligible cards that have been masked at the point of sale. In this example, the loyalty partner system 22 includes an OAuth API 510 and one or more partner APIs 512 to integrate with the loyalty hub platform 10, holds a membership record 514 (e.g., to store the BIN ranges discussed above), and hosts a partner merchant app 516.

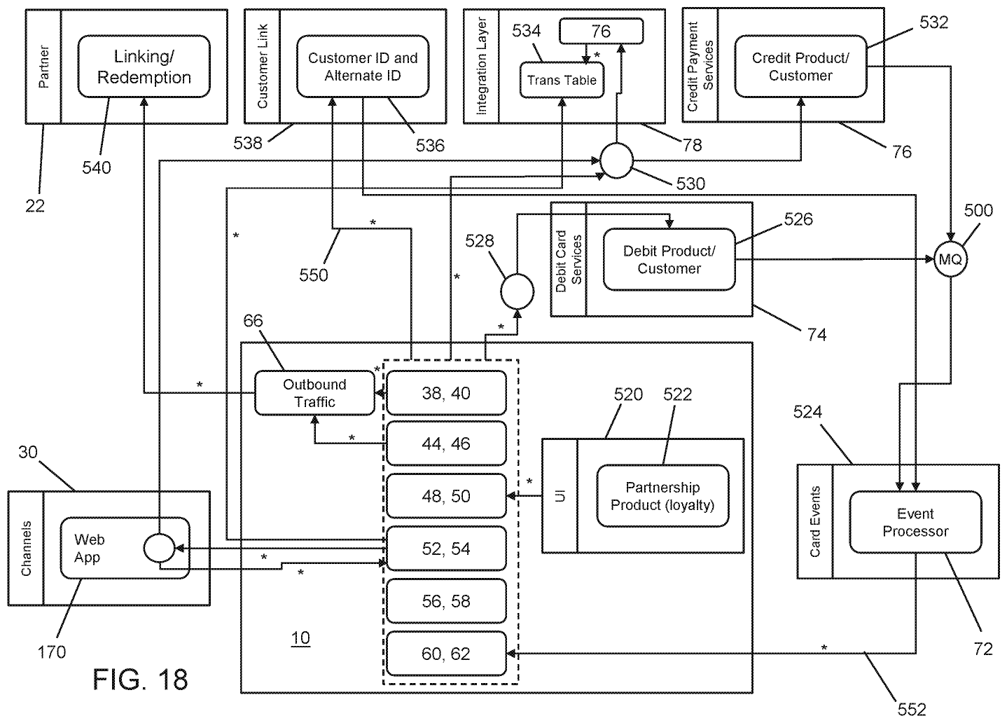

As discussed above, the enterprise system 16 and loyalty hub platform 10 can also be configured to remove PCI data from the cloud environment and to enable product analysis and customer-level linking. FIG. 18 illustrates an example of a configuration in which such PCI data is removed in certain dataflows. Such data flows, wherein the data is “non-PCI” data is identified using an asterisk “*” in FIG. 18. As shown, the event processor 72 receives PCI data via the MQ(s) 500 but processes the data to generate the non-PCI data. For example, a payment card number 1234567890127890 can be processed to output 123456*******7890+CustID, along with any other identifying information (e.g., CIF or alternative party IDs) about the user or customer. It can be seen that such non-PCI data is exchanged on the loyalty hub platform 10, which in this configuration is a cloud-based deployment. The channels 30, which can include the web-based application 170 can also exchange non-PCI data with the loyalty hub platform 10 as well as PCI data that is sent to the integration layer 78 and/or the credit payment services 76 via a hub 530. A customer link 538 can use a customer ID and Alternative ID module 536 to receive non-PCI data and convert to PCI data that is ultimately received by the event processor 72 as shown in FIG. 18. The integration layer can provide a transaction table 534 and the payment service 76 to exchange both PCI and non-PCI data. The partner system 22 can also include a linking/redemption module 540 that also receives non-PCI data.

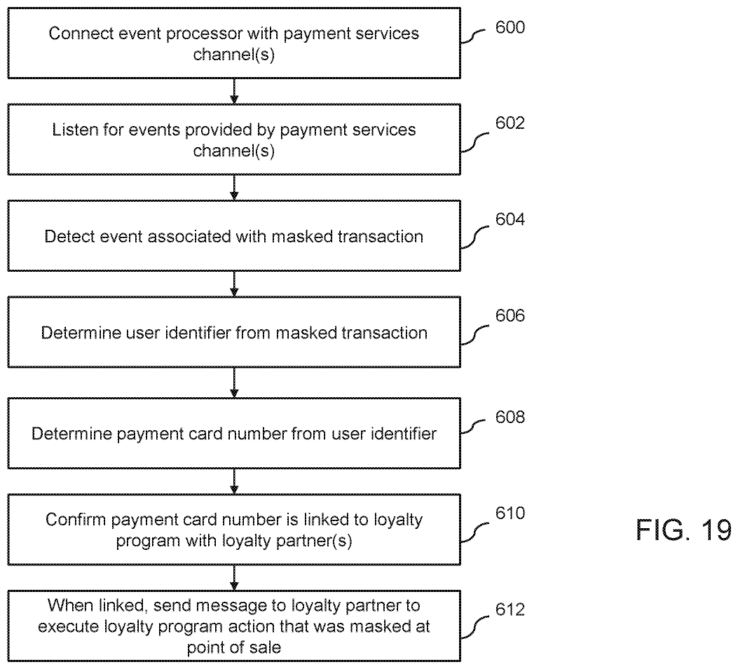

Referring now to FIG. 19, a flow diagram of an example of computer executable instructions for monitoring transaction events is provided. At block 600, the event processor 72 is connected with the payment services channels, e.g., credit card payment services 76 and/or debit card services 74. At block 602, the event processor 72 listens for events provided or otherwise obtained from the payment services 74, 76. At block 604, the event processor 72 detects an event associated with a masked transaction, e.g., by detecting a transaction type or other header information that can be used to determine that a third party payment service that masks the underlying payment card number has been used. At block 606, the event processor 72 determines a user identifier from or based on other information in the masked transaction and determines at block 608 the associated payment card number. At block 610, the event processor 72 confirms whether the payment card number is linked to a loyalty program with a loyalty partner system 22 such that the transaction at the point of sale would not have triggered the loyalty program's reward or additional/accelerated reward. When the payment card is linked to such a loyalty program, the event processor 72 can send a message to the corresponding loyalty partner system 22 to have a loyalty program action executed to account for the transaction that was masked at the point of sale.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. An event processor device for monitoring transaction events, the event processor device comprising:
a processor;
a communications module coupled to the processor; and
a memory coupled to the processor, the memory storing computer executable instructions that when executed by the processor cause the processor to:
connect the event processor device with at least one payment services channel via the communications module;
listen, via the communications module, for events provided by the at least one payment services channel;
detect an event associated with a masked transaction, the masked transaction being facilitated by a payment service that masks, at a point of sale, a payment card number issued by another party that is used by the payment service to execute the transaction, wherein the payment card number is associated with a loyalty program with a loyalty partner;
determine from the masked transaction a user identifier associated with the transaction;
determine from the user identifier the payment card number;
confirm that the payment card number is linked to the loyalty program with the loyalty partner; and
when the payment card number is linked to the loyalty program, send a message to the loyalty partner to have the loyalty partner execute a loyalty program action associated with the transaction that would have otherwise been masked at the point of sale.

2. The device of claim 1, wherein the masked transaction is associated with a third party payment account that is separate from a financial institution that issues the payment card number, wherein the third party payment account links one or more payment cards issued to the user to provide a separate electronic payment option.

3. The device of claim 1, wherein the event processor device is coupled to message queues connected to each of a plurality of payment channels.

4. The device of claim 1, wherein the computer executable instructions further cause the processor to:
detect an event associated with a standard transaction;
remove payment card industry data from the standard transaction; and
provide a modified transaction message to one or more microservices of a loyalty hub platform to process loyalty events.

5. The device of claim 4, wherein the event processor device is integrated with the loyalty hub platform and coupled to the one or more microservices.

6. The device of claim 1, wherein the computer executable instructions further cause the processor to:
provide the loyalty partner with a range of card numbers for a financial institution configured to provide a loyalty hub platform for at least the loyalty partner, wherein the range of card numbers is used at the point of sale to determine whether the payment card number is linked to the loyalty program.

7. The device of claim 6, wherein the range of card numbers is periodically updated at the loyalty partner by the loyalty hub platform.

8. The device of claim 1, wherein the event processor device is integrated with a loyalty hub platform and coupled to one or more microservices, and wherein the loyalty hub platform is configured to:
provide a first application programming interface (API) between the loyalty hub platform and one or more loyalty partner systems;
provide an inbound traffic service to the platform, to receive data from the one or more loyalty partner systems via the first API;
provide a second API between the platform and the at least one payment services channel to detect transactions;
provide an outbound traffic service from the platform, to communicate with the one or more loyalty partner systems via at least one communication channel;
configure a plurality of microservices within the platform, the plurality of microservices comprising a registration microservice to link loyalty accounts with enterprise accounts, a redemption microservice to associate the transactions with loyalty redemption events, a rules microservice to maintain sets of rules associated with loyalty partners, a profile management microservice to maintain profiles associated with accounts, and a lifecycle management microservice to manage lifecycle events; and
orchestrate the plurality of microservices using: i) data received via the inbound traffic service, ii) transaction data detected via the second API, or both i) and ii), to update a corresponding loyalty partner system via the outbound traffic service to execute at least one of a registration event, a redemption event, a profile event, and a lifecycle event.

9. The device of claim 8, wherein the loyalty hub platform is integrated with an enterprise system to link a first loyalty program associated with the enterprise system with at least one second loyalty program each associated with one of the loyalty partner systems.

10. The device of claim 9, wherein the enterprise system provides a payment card for making purchases, the payment card being a physical card, an electronic card, or providing both the physical card and the electronic card.

11. The device of claim 10, wherein the computer executable instructions further cause the processor to:
track purchases made using the payment card;
link the purchases with a product or service provided by a merchant providing the second loyalty program associated with the one of the loyalty partner systems; and
provide an additional loyalty reward based on the purchases.

12. A method of monitoring transaction events, the method executed by an event processor device and comprising:
connecting the event processor device with at least one payment services channel;
listening for events provided by the at least one payment services channel;
detecting an event associated with a masked transaction, the masked transaction being facilitated by a payment service that masks, at a point of sale, a payment card number issued by another party that is used by the payment service to execute the transaction, wherein the payment card number is associated with a loyalty program with a loyalty partner;
determining from the masked transaction a user identifier associated with the transaction;
determining from the user identifier the payment card number;
confirming that the payment card number is linked to the loyalty program with the loyalty partner; and
when the payment card number is linked to the loyalty program, sending a message to the loyalty partner to have the loyalty partner execute a loyalty program action associated with the transaction that would have otherwise been masked at the point of sale.

13. The method of claim 12, wherein the masked transaction is associated with a third party payment account that is separate from a financial institution that issues the payment card number, wherein the third party payment account links one or more payment cards issued to the user to provide a separate electronic payment option.

14. The method of claim 12, wherein the event processor device is coupled to message queues connected to each of a plurality of payment channels.

15. The method of claim 12, further comprising:
detecting an event associated with a standard transaction;
removing payment card industry data from the standard transaction; and
providing a modified transaction message to one or more microservices of a loyalty hub platform to process loyalty events.

16. The method of claim 15, wherein the event processor device is integrated with the loyalty hub platform and coupled to the one or more microservices.

17. The method of claim 12, further comprising:
providing the loyalty partner with a range of card numbers for a financial institution configured to provide a loyalty hub platform for at least the loyalty partner, wherein the range of card numbers is used at the point of sale to determine whether the payment card number is linked to the loyalty program.

18. The method of claim 17, wherein the range of card numbers is periodically updated at the loyalty partner by the loyalty hub platform.

19. The method of claim 12, wherein the event processor device is integrated with a loyalty hub platform and coupled to one or more microservices, and further comprising:
providing a first application programming interface (API) between the loyalty hub platform and one or more loyalty partner systems;
providing an inbound traffic service to the platform, to receive data from the one or more loyalty partner systems via the first API;
providing a second API between the platform and the at least one payment services channel to detect transactions;
providing an outbound traffic service from the platform, to communicate with the one or more loyalty partner systems via at least one communication channel;
configuring a plurality of microservices within the platform, the plurality of microservices comprising a registration microservice to link loyalty accounts with enterprise accounts, a redemption microservice to associate the transactions with loyalty redemption events, a rules microservice to maintain sets of rules associated with loyalty partners, a profile management microservice to maintain profiles associated with accounts, and a lifecycle management microservice to manage lifecycle events; and
orchestrating the plurality of microservices using: i) data received via the inbound traffic service, ii) transaction data detected via the second API, or both i) and ii), to update a corresponding loyalty partner system via the outbound traffic service to execute at least one of a registration event, a redemption event, a profile event, and a lifecycle event.

20. A non-transitory computer readable medium for monitoring transaction events, the computer readable medium comprising computer executable instructions for:
connecting an event processor device with at least one payment services channel;
listening for events provided by the at least one payment services channel;
detecting an event associated with a masked transaction, the masked transaction being facilitated by a payment service that masks, at a point of sale, a payment card number issued by another party that is used by the payment service to execute the transaction, wherein the payment card number is associated with a loyalty program with a loyalty partner;
determining from the masked transaction a user identifier associated with the transaction;
determining from the user identifier the payment card number;
confirming that the payment card number is linked to the loyalty program with the loyalty partner; and
when the payment card number is linked to the loyalty program, sending a message to the loyalty partner to have the loyalty partner execute a loyalty program action associated with the transaction that would have otherwise been masked at the point of sale.
